(19) United States
(12) Patent Application Publication
(10) Pub. No.: US 2014/0023887 A1
(43) Pub. Date: Jan. 23, 2014

(54) POUCHED TYPE SECONDARY BATTERY INCLUDING GAS DISCHARGING DEVICE AND GAS DISCHARGING CONTROL METHOD

(71) Applicant: Jae Hwan Lim, Daejeon (KR)

(72) Inventor: Jae Hwan Lim, Daejeon (KR)

(73) Assignee: SK INNOVATION CO., LTD., Seoul (KR)

(21) Appl. No.: 14/007,109

(22) PCT Filed: Mar. 23, 2012
(86) PCT No.: PCT/KR2012/002101

§ 371 Date: Sep. 24, 2013

(30) Foreign Application Priority Data
Mar. 25, 2011 (KR) 10-2011-0026865

(51) Int. Cl. H01M 2/12

(52) U.S. Cl. CPC H01M 2/12
USPC 429/50; 429/71; 429/61

(57) ABSTRACT

The present invention relates to a pouch-type secondary battery including a gas discharging device and a gas discharging control method, comprising: a plurality of pouched type cell modules including a pair of pouched type cells sealed by a pouch, having cathode taps and anode taps drawn to the outside of one side of the pouch, and sequentially laminated to each other, and a cell case coupled to seal the pouches of the pouched type cells; a gas discharging hole which is formed at and communicates with one side of the cell case; a connective duct which is coupled and communicates with the gas discharging hole; and a fan which is formed at one side of the connective duct.

### TECHNICAL FIELD

The present invention relates to a pouched type secondary battery including a gas discharging device, and a gas discharging control method, and more particularly, to a pouched type secondary battery including a gas discharging device, the pouched type secondary battery including: a plurality of pouched type cell modules sequentially laminated to each other and including a pair of pouched type cells sealed by a pouch, having cathode taps and anode taps drawn to the outside of one side of the pouch, and sequentially laminated to each other, and a cell case coupled to seal the pouches of the pouched type cells; a gas discharging hole which is formed at and communicates with one side of the cell case; a connective duct which is coupled and communicates with the gas discharging hole; and a fan which is formed at one side of the connective duct, such that a large amount of flammable gas generated by an inner short-circuit or an overcharge of the pouched type cell is collected in a predetermined portion of the cell to be rapidly discharged, whereby ignition or explosion possibility may be decreased.

In addition, the present invention relates to a gas discharging control method in which a temperature and a voltage of the pouched type cell module are measured, and at the time of reaching a predetermined abnormal condition, the fan is driven to allow the gas to be rapidly discharged.

### BACKGROUND ART

In general, a secondary battery is capable of being charged and discharged to be applied to various fields such as a digital camera, a cellular phone, a notebook and a hybrid car, unlike a primary battery, and research thereof has been actively conducted. Examples of the secondary battery may include a nickel-cadmium battery, a nickel-metal hydride battery, a nickel-hydrogen battery, and a lithium secondary battery.

The lithium secondary battery is capable of being manufactured so as to have various shapes, and a representative shape thereof may be a cylindrical type and a prismatic type which are mainly used in a lithium ion battery. A lithium polymer battery recently in the spotlight is manufactured in a pouched type having flexibility, such that the shape thereof is relatively varied.

Since the pouched type lithium polymer battery (hereinafter, referred to as a “pouched typed cell”) is easily bent or curved, a compact case is coupled to the outside thereof, such that the pouched type lithium polymer battery is usable in a long term period.

However, the secondary battery configured by laminating the pouched type cells according to the related art is manufactured by adding an organic solvent, a plasticizer, and the like, to the battery, in order to improve output property or capacitance property.

In addition, since an overcharge occurs during a charging and discharging process or an inner short-circuit occurs due to defect of the specific cells in a number of cells, a temperature in the cell is instantly increased, which generates a flammable gas causing a swelling phenomenon in that the pouch is swelled.

Accordingly, when a side surface, or the like, of the pouch is burst, a large amount of flammable gas is discharged, and in this case, as shown in FIG. 1, the pouched type cell according to the related art includes an electrode body 10, a cathode terminal 11 and an anode terminal 12 connected to the electrode body 10 and formed in one side thereof, a pouch 20 sealing the electrode body 10, and an exhaust member 30 disposed so as to be spaced apart from the electrode body 10 at a predetermined distance, wherein the pouch 20 covers the electrode body 10 and the exhaust member 30, such that the periphery is welded and sealed, and the exhaust member 30 has a ventilation hole 31 formed therein to communicate with a connective pipe 40.

In addition, the pouch 20 welded between the electrode body 10 and the exhaust member 30 has a safety plate 21 formed therein.

Accordingly, in the pouched type cell according to the related art, in the case in which the gas is generated due to the overcharge or the short-circuit of the electrode body 10, the safety plate 21 falls down, and the gas generated in the electrode body 10 is discharged to the exhaust member 30 and along the connective pipe 40 communicating with the ventilation hole 31, such that an ignition or explosion possibility may be prevented.

However, the pouched type cell according to the related art as described above is difficult to be manufactured since the structure thereof is complicated and the safety plate 21 should be formed in the pouch 20.

In addition, since the pouched type cell is easily bent or curved due to weak strength, a compact case is coupled to the outside thereof, wherein when a gas is generated due to the overcharge or the short-circuit, the compact case does not include a device capable of discharging the gas to the specific portion, such that the flammable gas may not be rapidly discharged, and therefore, the pouched type cell according to the related art has ignition or explosion possibility due to the remaining gas in the case.

### TECHNICAL PROBLEM

An object of the present invention is to provide a pouched type secondary battery including a gas discharging device, the pouched type secondary battery including: a plurality of pouched type cell modules sequentially laminated to each other and including a pair of pouched type cells sealed by a pouch, having cathode taps and anode taps drawn to the outside of one side of the pouch, and sequentially laminated to each other, and a cell case coupled to seal the pouches of the pouched type cells; a gas discharging hole which is formed at and communicates with one side of the cell case; a connective duct which is coupled and communicates with the gas discharging hole; and a fan which is formed at one side of the connective duct, such that at the time of an inner short-circuit or an overcharge of the pouched type cell, a flammable gas is generated, and a large amount of flammable gas that is discharged when a portion of the pouch is burst is collected in a predetermined portion of the cell to be rapidly discharged, whereby ignition or explosion possibility may be decreased.

In addition, another object of the present invention is to provide a gas discharging control method in which a temperature and a voltage of the pouched type cell module are measured, and at the time of reaching a predetermined abnormal condition, the fan is driven to allow the gas to be rapidly discharged.

### TECHNICAL SOLUTION

In one general aspect, a pouched type secondary battery including a gas discharging device, the pouched type secondary battery includes: a plurality of pouched type cell modules sequentially laminated to each other and including a pair of pouched type cells having an electrode body sealed by a pouch, and cathode taps and anode taps drawn to the outside of one side of the pouch, and sequentially laminated to each other, and a cell case coupled to seal the pouches of the pouched type cells; a gas discharging hole which is formed at and communicates with one side of the cell case; a connective duct which is coupled and communicates with the gas discharging hole; and a fan which is formed at one side of the connective duct.

The cell case of the pouched type cell module may include a pair of covers supporting an outer side surface of the pouch of the pair of pouched type cells sequentially laminated to each other; and a partition interposed between the pair of pouched type cells.

The cover may include a protrusion part formed on a surface in which the pouched type cell modules are laminated.

The pouched type secondary battery as described above may further include: a temperature measuring part measuring a temperature of the pouched type cell module; a voltage measuring part measuring a voltage of the pouched type cell module; a fan driving part driving the fan; and a controlling part receiving a temperature value of the pouched type cell module from the temperature measuring part and a voltage value of the pouched type cell module from the voltage measuring part, and outputting a controlling signal for driving the fan depending on the temperature value and the voltage value to the fan driving part.

The controlling part may allow the fan to be driven in the case in which the measured temperature value is higher than a predetermined reference temperature value or the measured voltage value is higher than a predetermined reference voltage value.

The controlling part may break the relay in the case in which the measured temperature value is higher than the predetermined reference temperature value or the measured voltage value is higher than the predetermined reference voltage value.

In another general aspect, a gas discharging control method of a pouched type secondary battery including a gas discharging device, the gas discharging control method includes: measuring, by a temperature measuring part, a temperature of the pouched type cell module and measuring, by a voltage measuring part, a voltage of the pouched type cell module, and outputting the measured temperature and voltage to a controlling part; determining whether or not a temperature value received in the controlling part is higher than a predetermined reference temperature value or a voltage value received in the controlling part is higher than a predetermined reference voltage value; and driving a fan in the case in which it is determined that the received temperature value is higher than the predetermined reference temperature value or the received voltage value is higher than the predetermined reference voltage value.

The driving of the fan may further include breaking the relay electrically connected to the pouched type cell module when the fan is driven.

The reference temperature value may be 70° C. and the reference voltage value may be 4.7V.

### ADVANTAGEOUS EFFECTS

With the pouched type secondary battery including the gas discharging device and the gas discharging control method according to the present invention, the pouched type secondary battery including the gas discharging device may include: the gas discharging hole which is formed at and communicates with one side of the cell case of a plurality of pouched type cell modules sequentially laminated to each other; the connective duct which is coupled and communicates with the gas discharging hole; and the fan which is formed at one side of the connective duct, such that at the time of the inner short-circuit or the overcharge of the pouched type cell, the flammable gas is generated, and the large amount of flammable gas that is discharged when the portion of the pouch is burst may be collected in the predetermined portion of the cell to be rapidly discharged. In addition, the temperature and the voltage of the pouched type cell module are measured, and at the time of reaching the predetermined abnormal condition, the fan is driven to allow the gas to be rapidly discharged, whereby ignition or explosion possibility may be decreased.

### DESCRIPTION OF DRAWINGS

FIGS. 1 and 2 are schematic diagrams showing a gas discharging device of a secondary battery according to the related art;

FIGS. 3 to 5 are perspective view and side view showing a pouched type secondary battery including a gas discharging device according to the present application;

FIG. 6 is a cross sectional view taken along the line AA′ of FIG. 5;

FIG. 7 is an exploded perspective view of a pouched type cell module according to the present invention;

FIG. 8 is a configuration diagram showing each part for a gas discharging control of the pouched type secondary battery including the gas discharging device according to the present invention; and

FIG. 9 is a view showing each step of a gas discharging control method of the pouched type secondary battery including the gas discharging device according to the present invention.

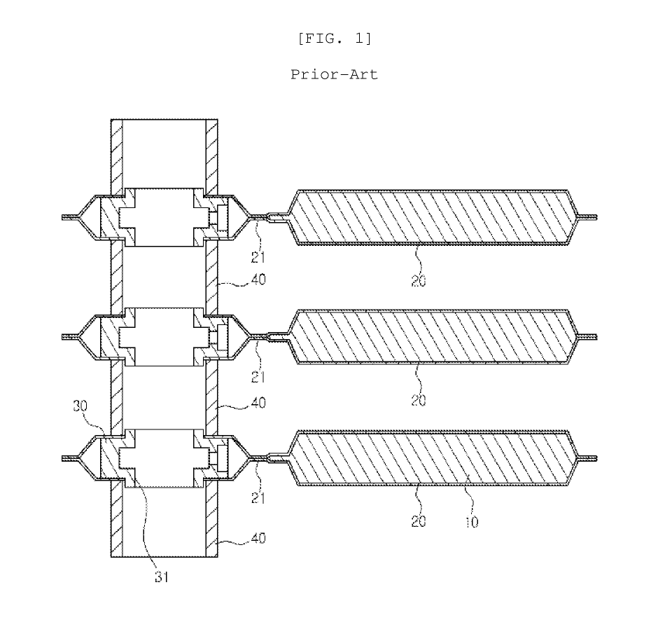

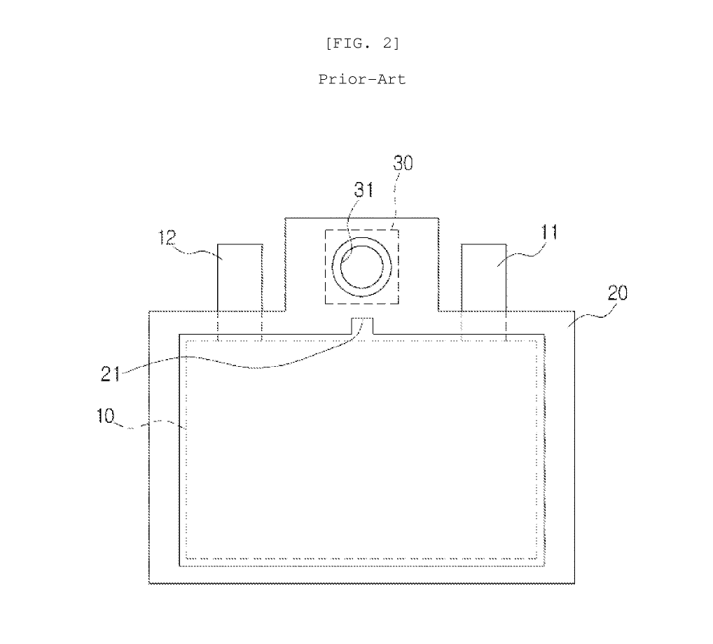

### BEST MODE

Hereinafter, a pouched type secondary battery including a gas discharging device according to the present invention and a gas discharging control method will be described in detail with reference to the accompanying drawings.

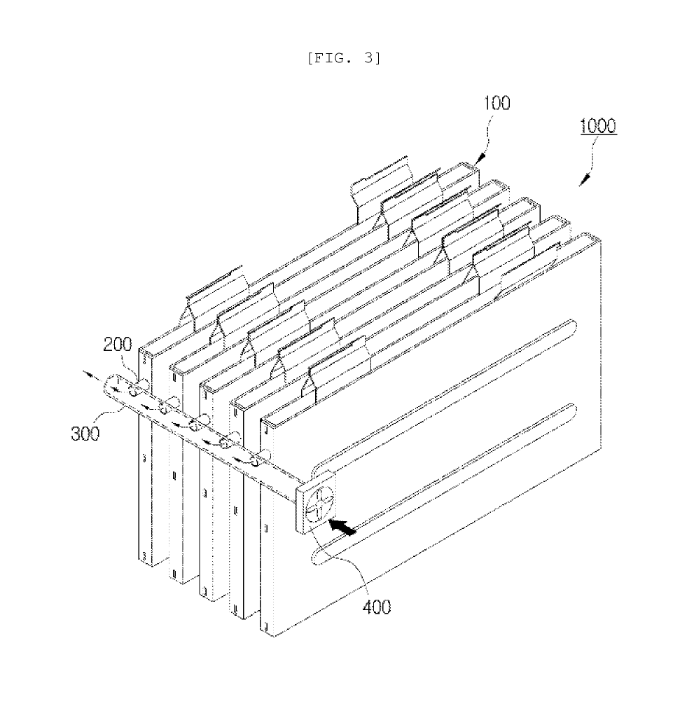

FIG. 3 is a perspective view showing the pouched type secondary battery including the gas discharging device according to the present application.

As shown in FIG. 3, the pouched type secondary battery 1000 including the gas discharging device according to the present invention may include a plurality of pouched type cell modules 100 sequentially laminated to each other and including a pair of pouched type cells 130 having an electrode body 110 sealed by a pouch 120, and cathode taps 111 and anode taps 112 drawn to the outside of an upper side of the pouch 120, and sequentially laminated to each other, and a cell case 140 coupled to seal the pouches 120 of the pouched type cells 130; a gas discharging hole 200 which is formed at and communicates with one side of the cell case 140; a connective duct 300 which is coupled and communicates with the gas discharging hole 200; and a fan 400 which is formed at one side of the connective duct 300.

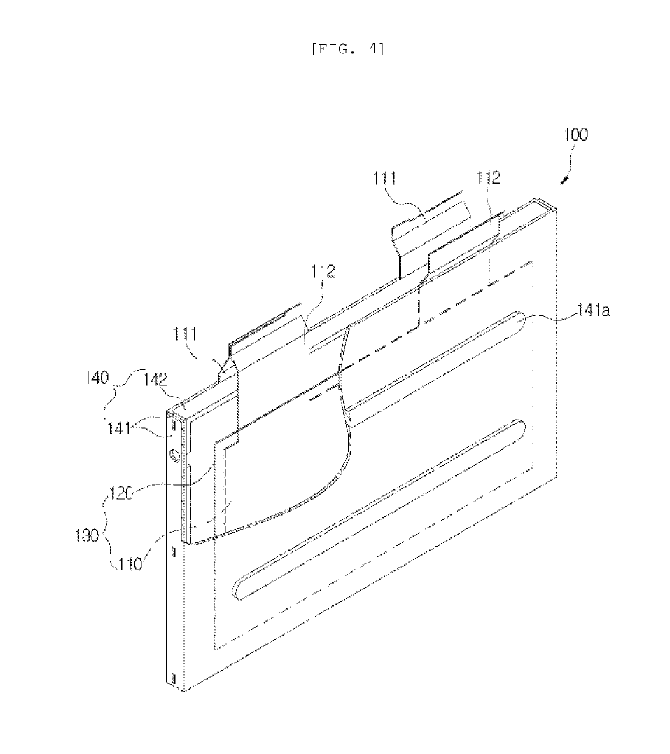

First, in the pouched type cell module 100, the pouch 120 surrounds an outer surface of the electrode body 110 so that the electrode body 110 of the pouched type cell 130 is sealed by the pouch 120 as shown in FIG. 4.

In addition, the cathode tabs 111 and the anode tabs 112 extended to the one side of the electrode body 110 are drawn to the outside of the pouch 120.

That is, in the pouched type cell 130, the cathode tabs 111 and the anode tabs 112 are extended to one side of the electrode body 110, and the pouch 120 surrounds only the electrode body 110 except for the cathode tabs 111 and the anode tabs 112 so that the electrode body 110 is sealed.

In addition, a pair of pouched type cell 130 formed as described above are sequentially laminated to each other, and include the cell case 140 coupled to an outer side surface so that the pouch 120 is sealed.

That is, a portion surrounded by the pouch 120 except for the cathode tab 111 and the anode tab 112 of the pouched type cell 130 is surrounded again by the cell case 140 to be sealed by the cell case 140.

Here, it is preferred that the cell case 140 is not closed to the pouch 120 so as to have a predetermined space secured therein.

Accordingly, the pouched type cell module 100 is formed so that the cathode tab 111 and the anode tab 112 are drawn to the outside of one side of the cell case 140, the electrode body 110 is sealed by the pouch 120, and sealed again due to the cell case 140 coupled to the outer side of the pouch 120, thereby having a double sealed structure.

Here, the electrode body 110 of the pouched type cell 130 is configured of a cathode, an anode, an electrolyte, and a separating plate which separates the anode and the cathode so that electricity is charged and discharged, and the cathode tab 111 and the anode tab 112 transmit a current generated from the electrode body 110 at the time of discharging or a current introduced from the outside at the time of charging.

In the pouched type cell module 100 formed as described above, a plurality of the pouched type cell modules 100 are sequentially laminated to each other, the cathode tab 111 or the anode tab 112 drawn to the outside of the cell case 140 is coupled to a pair of cathode tabs 111 of one pouched type cell module 100, and the anode tab 112 is coupled to the anode tab 112 of the pouched type cell module 100 adjacent to each other, thereby being connected in series or in parallel.

Here, the cathode tab 111 and the anode tab 112 may be coupled by using a connector, or a connective plate, or may be coupled by a laser or an ultrasonic welding.

As described above, the plurality of pouched type cell modules 100 is formed, and a gas discharging hole 200 is extended to one side of the cell case 140 of each of the pouched type cell module 100.

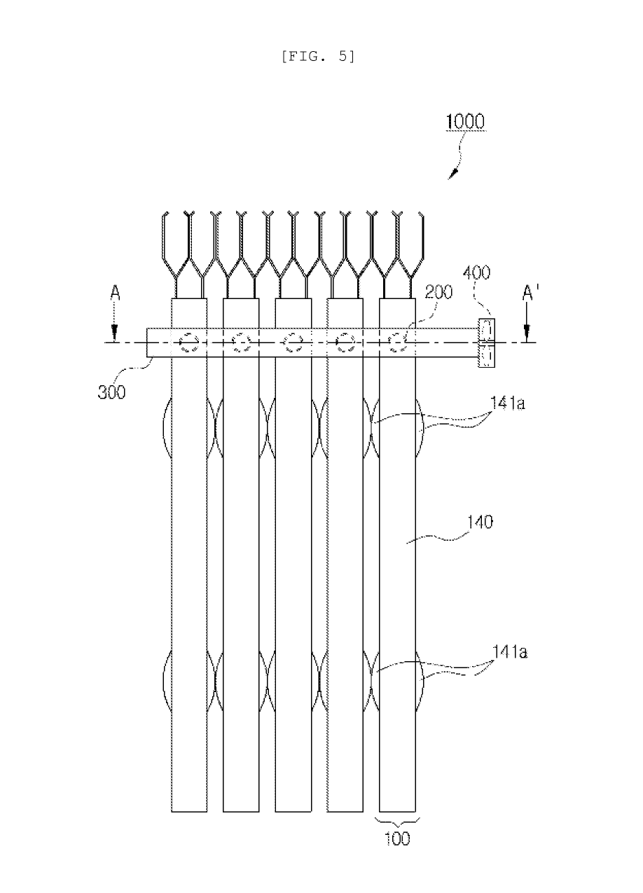

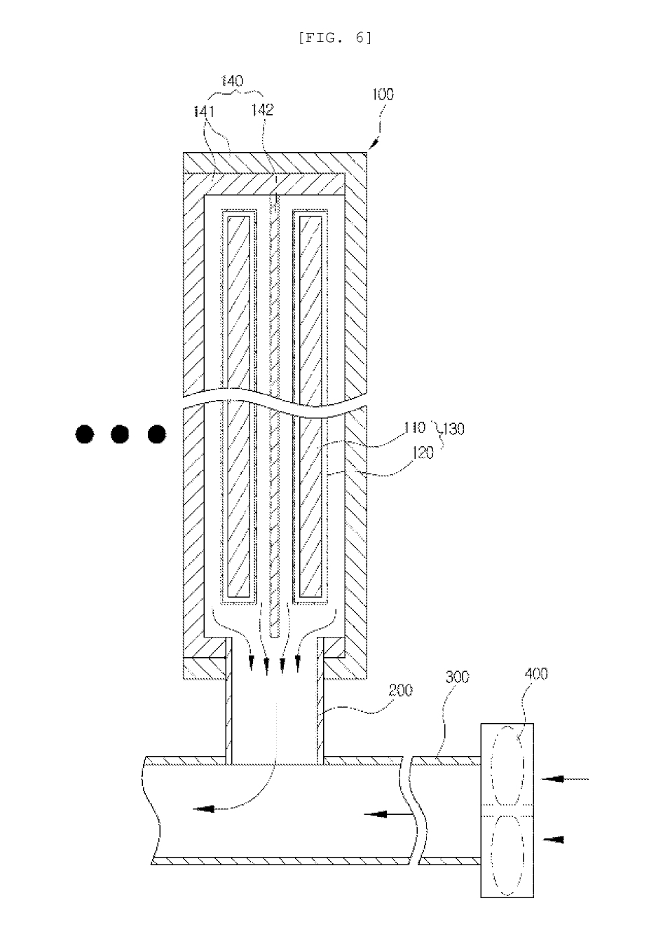

Here, the gas discharging hole 200 is formed on a side surface of the cell case 140 rather than a surface in which the cell cases 140 are laminated and communicates with an inner space of the cell case 140 as shown in FIG. 5.

In addition, a connective duct 300 which is coupled and communicates with each of the gas discharging holes 200 is formed.

Here, the gas discharging hole 200 is not extended from the cell case 140 but has a through hole formed in the cell case 140, such that the connective duct 300 may be directly coupled to the cell case 140.

In addition, a fan 400 is formed at one side of the connective duct 300.

Accordingly, when the fan 400 is driven, air flows along the connective duct 300, wherein a flammable gas generated in the cell case 140 along the gas discharging hole 200 communicating with the connective duct 300 is rapidly discharged through the connective duct 300.

When summarizing the description above, the charging and the discharging are repeated in the electrode body 110 of the pouched type cell 130, such that electricity is produced or discharged. However, in the case in which a short-circuit occurs in the pouched type cell 130 due to repeated charging and discharging process or shock, or an overcharge occurs during the charge process, a temperature in the cell is instantly increased, which generates the flammable gas to cause a swelling phenomenon in that the pouch 120 is swelled.

Here, a large amount of flammable gas is discharged when a side surface, or the like, of the pouch 120 is burst, wherein the discharged gas is collected in the cell case 140.

The gas collected in the cell case 140 passes through the gas discharging hole 200 to flow into the connective duct 300, and the fan 400 formed at one side of the connective duct 300 is driven, such that the air is blown into the connective duct 300 and is discharged to the other side of the connective duct 300 along the flammable gas.

Accordingly, at the time of the inner short-circuit or the overcharge of the pouched type cell 130, the flammable gas is generated, and the large amount of flammable gas that is discharged when a portion of the pouch 120 is burst may be collected in a predetermined portion of the cell to be rapidly discharged, whereby ignition or explosion possibility may be decreased.

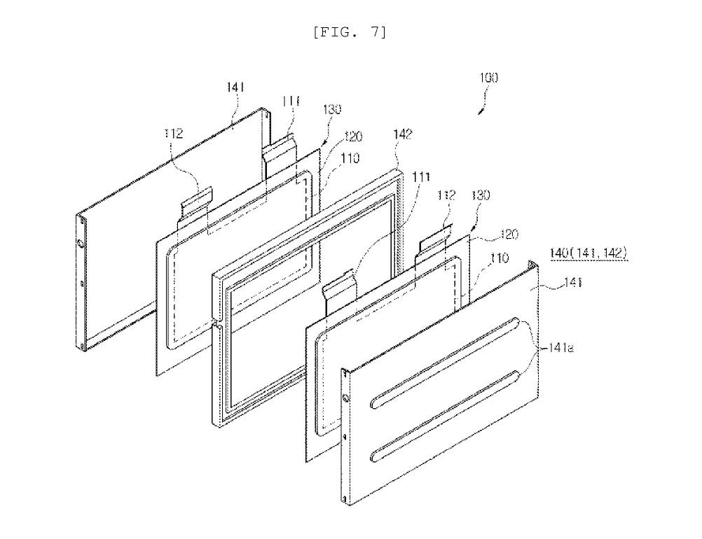

In addition, the cell case 140 of the pouched type cell module 100 may include a pair of covers 141 supporting an outer side surface of the pouch 120 of the pair of pouched type cells 130 sequentially laminated; and a partition 142 interposed between the pair of pouched type cells 130 as shown in FIG. 7.

That is, the partition 142 is inserted between the pair of pouched type cells 130 and the pair of covers 141 support the outer side surface of the pouch 120.

Accordingly, the cell case 140 may easily seal the pouch 120 of the pouched type cell 130, and the partition 142 may prevent the short-circuit between the pair of pouched type cells 130.

Here, the pouched type cell module 100 is configured so that one pouched type cell 130 is inserted into the cell case 140 formed to be integrated as one in order to seal an upper side; however, in the case of the pouched type cell module configured of the pair of pouched type cells 130, the partition 142 is interposed between the pouched type cells 130 and two covers 141 are coupled at both sides, thereby being easily manufactured.

In addition, the partition 142 may be formed in a frame in which an inner side is hollow, and the hollow inner side may be coupled with a damping material.

In addition, the cover 141 may have a protrusion part 141a formed on a surface in which the pouched type cell modules 100 are laminated.

That is, the protrusion part 141a is formed on the surface of the cover 141 in which the pouched type cell modules 100 are laminated, such that due to the protrusion part 141a, the laminated surface may be not closed but have a predetermined gap.

Accordingly, cooling air may flow between the plurality of pouched type cell modules 100, such that a heat generated at the time of charging and discharging may be effectively cooled.

Further, the cover 141 of the cell case 140 may have high thermal conductivity to provide excellent heat radiation property, and may be formed of aluminum which is a material having excellent structural stability, and the partition 142 may be formed of plastic which is an electrical non-conductor, which is appropriate for preventing the short-circuit between the pouched type cells 130.

In addition, the pouched type secondary battery 1000 including the gas discharging device according to the present invention may further include a temperature measuring part 600 measuring a temperature of the pouched type cell module 100; a voltage measuring part 700 measuring a voltage of the pouched type cell module 100; a fan driving part 800 driving the fan 400; and a controlling part 900 receives a temperature value of the pouched type cell module 100 from the temperature measuring part 600 and a voltage value of the pouched type cell module 100 from the voltage measuring part 700, and outputs a controlling signal for driving the fan 400 depending on the temperature value and the voltage value to the fan driving part 800.

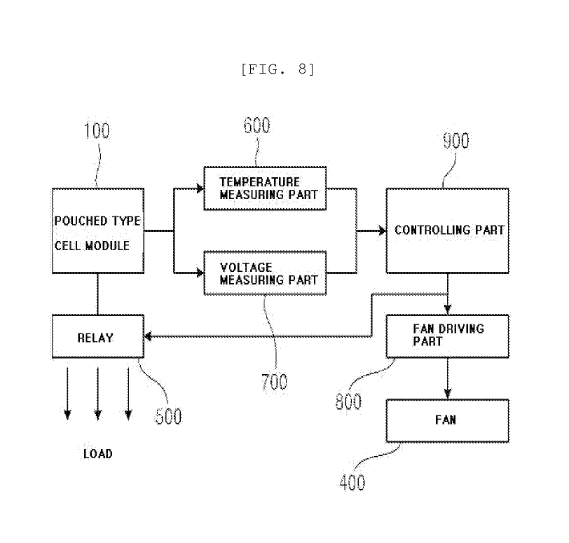

That is, as shown in FIG. 8, a temperature value and a voltage value of the pouched type cell module 100 are measured in the temperature measuring part 600 and the voltage measuring part 700, respectively, and the measured values are received in the controlling part 900, such that the controlling signal is received from the controlling part 900 to the fan driving part 800 according to the temperature value and the voltage value, whereby the driving of the fan 400 may be controlled.

Here, each of the plurality of pouched type cell modules 100 may have the temperature measuring part 600, and the voltage measuring part 700 may be connected to a protection circuit or a battery controlling device such as a battery management system (BMS), or the like, connected to the electrode tabs 111 and 112, respectively.

In addition, the controlling part 900 may allow the fan 400 to be driven in the case in which the measured temperature value is higher than a predetermined reference temperature value or the measured voltage value is higher than a predetermined reference voltage value.

That is, in the case in which the measured temperature value of the pouched type cell module is higher than the predetermined reference temperature value or the measured voltage value of the pouched type cell module is higher than the predetermined reference voltage value, the fan 400 is driven, such that the flammable gas is discharged, whereby ignition or explosion may be prevented.

In addition, the controlling part 900 may allow a relay 500 electrically connected to the pouched type cell module to be broken in the case in which the measured temperature value is higher than the predetermined reference temperature value or the measured voltage value is higher than the predetermined reference voltage value.

That is, in the case in which the measured temperature value and the measured voltage value of the pouched type cell module 100 are higher than the predetermined reference temperature value and the predetermined reference voltage value, respectively, the relay 500 may be broken, such that the overcharge and overdischarge of the pouched type cell 130 may be prevented.

In addition, the gas discharging control method of the pouched type secondary battery including the gas discharging device according to the present invention, the gas discharging control method may include: measuring a temperature of the pouched type cell module 100 by a temperature measuring part 600 and measuring a voltage of the pouched type cell module 100 by a voltage measuring part 700 and outputting the measured temperature and voltage to a controlling part 900 S10; determining whether or not a temperature value received in the controlling part 900 is higher than a predetermined reference temperature value or a voltage value received in the controlling part 900 is higher than a predetermined reference voltage value S20; and driving a fan 400 in the case in which it is determined that the received temperature value is higher than the predetermined reference temperature value or the received voltage value is higher than the predetermined reference voltage value.

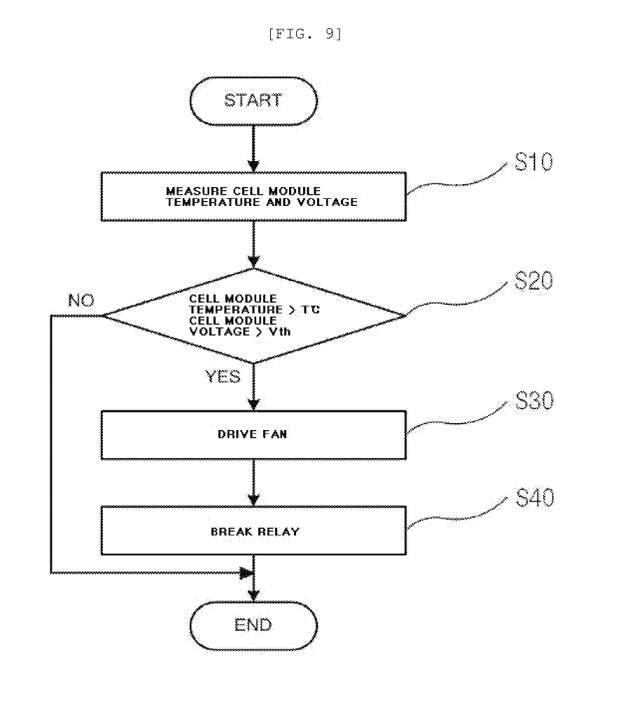

FIG. 9 is a view showing each step of the gas discharging control method of the pouched type secondary battery including the gas discharging device according to the present invention.

As shown in FIG. 9, whether or not the temperature and the voltage of the pouched type cell module 100 are increased due to the inner short-circuit, overcharge, or overdischarge may be measured in step S10, the measured temperature value and the voltage value may be comparatively determined with the predetermined reference temperature voltage value and the predetermined reference voltage value in step S20, and the fan 400 may be driven in the case in which the measured temperature value is higher than the predetermined reference temperature value or the measured voltage value is higher than the predetermined reference voltage value in step S30.

Here, in the driving of the fan 400 S30, when the fan 400 is driven, breaking the relay 500 connected to the controlling part 900 S40 may be further performed, wherein the reference temperature value may be 70° C. and the reference voltage value may be 4.7V.

That is, in the case in which the temperature and measured in the pouched type cell module 100 is higher than 70° C. or the voltage measured in the pouched type cell module 100 is higher than 4.7V, it is determined that the inner short-circuit, overcharge or overdischarge of the pouched type cell 130 may occur, such that one side of the pouch 120 of the pouched type cell 130 is burst, whereby the flammable gas is generated, and accordingly, the fan 400 may be driven and the relay 500 may be broken.

Therefore, in the case in which the fan 400 is driven, it is determined that the pouched type cell module 100 has a defect such as the inner short-circuit, overcharge, or the overdischarge, such that the relay 500 is broken by the controlling part 900, whereby other non-defective cell modules 100 except for the defective cell modules 100 may be protected.

In addition, the relay 500 may be broken to prevent an overcurrent from being supplied to the battery control device or electrical devices connected to the pouched type cell module 100.

As described above, when the temperature and the voltage of the pouched type cell module are measured and the measured values reach a predetermined abnormal condition, the fan is driven to allow the flammable gas to be rapidly discharged, such that the ignition or explosion possibility may be decreased, and various electrical devices may be protected.

Here, the reference voltage value, 4.7V is a voltage when the pair of pouched type cells 130 are laminated in the pouched type cell module 100 and the cathode tab 111 and the anode tab 112 of the pouched type cells 130 are connected in series, wherein in the case in which the tabs are connected in parallel or the number of pouched type cells 130 configuring the pouched type cell module 100 is changed, the reference value determining whether or not the voltage is abnormal may be changed. Similar to the above-description, the reference temperature value, 70° C. may be changed according to factors such as a constitution of the pouched type cell module 100, a cooling structure, and the like.

The present invention is not limited to the above-mentioned embodiments but may be variously applied. In addition, it will be appreciated by those skilled in the art that various modifications and changes may be made without departing from the appended claims of the present invention.

1. A pouched type secondary battery including a gas discharging device, the pouched type secondary battery comprising:
a plurality of pouched type cell modules sequentially laminated to each other and including a pair of pouched type cells having an electrode body sealed by a pouch, and cathode taps and anode taps drawn to the outside of one side of the pouch, and sequentially laminated to each other, and a cell case coupled to seal the pouches of the pouched type cells;
a gas discharging hole which is formed at and communicates with one side of the cell case;
a connective duct which is coupled and communicates with the gas discharging hole; and
a fan which is formed at one side of the connective duct.

2. The pouched type secondary battery of claim 1, wherein the cell case of the pouched type cell module includes a pair of covers supporting an outer side surface of the pouch of the pair of pouched type cells sequentially laminated to each other; and
a partition interposed between the pair of pouched type cells.

3. The pouched type secondary battery of claim 2, wherein the cover includes a protrusion part formed on a surface in which the pouched type cell modules are laminated.

4. The pouched type secondary battery of claim 1, further comprising:
a temperature measuring part measuring a temperature of the pouched type cell module;
a voltage measuring part measuring a voltage of the pouched type cell module;
a fan driving part driving the fan; and
a controlling part receiving a temperature value of the pouched type cell module from the temperature measuring part and a voltage value of the pouched type cell module from the voltage measuring part, and outputting a controlling signal for driving the fan depending on the temperature value and the voltage value to the fan driving part.

5. The pouched type secondary battery of claim 4, wherein the controlling part allows the fan to be driven in the case in which the measured temperature value is higher than a predetermined reference temperature value or the measured voltage value is higher than a predetermined reference voltage value.

6. The pouched type secondary battery of claim 5, wherein a relay is electrically connected to the pouched type cell module and the controlling part breaks the relay in the case in which the measured temperature value is higher than the predetermined reference temperature value or the measured voltage value is higher than the predetermined reference voltage value.

7. A gas discharging control method of a pouched type secondary battery including a gas discharging device, the gas discharging control method comprising:
measuring, by a temperature measuring part, a temperature of the pouched type cell module and measuring, by a voltage measuring part, a voltage of the pouched type cell module, and outputting the measured temperature and voltage to a controlling part;
determining whether or not a temperature value received in the controlling part is higher than a predetermined reference temperature value or a voltage value received in the controlling part is higher than a predetermined reference voltage value; and
driving a fan in the case in which it is determined that the received temperature value is higher than the predetermined reference temperature value or the received voltage value is higher than the predetermined reference voltage value.

8. The gas discharging control method of claim 7, wherein the driving of the fan further includes breaking the relay electrically connected to the pouched type cell module when the fan is driven.

9. The gas discharging control method of claim 7, wherein the reference temperature value is 70° C. and the reference voltage value is 4.7V.

10. The pouched type secondary battery of claim 2, further comprising:
a temperature measuring part measuring a temperature of the pouched type cell module;
a voltage measuring part measuring a voltage of the pouched type cell module;
a fan driving part driving the fan; and
a controlling part receiving a temperature value of the pouched type cell module from the temperature measuring part and a voltage value of the pouched type cell module from the voltage measuring part, and outputting a controlling signal for driving the fan depending on the temperature value and the voltage value to the fan driving part.

11. The pouched type secondary battery of claim 3, further comprising:
a temperature measuring part measuring a temperature of the pouched type cell module;
a voltage measuring part measuring a voltage of the pouched type cell module;
a fan driving part driving the fan; and
a controlling part receiving a temperature value of the pouched type cell module from the temperature measuring part and a voltage value of the pouched type cell module from the voltage measuring part, and outputting a controlling signal for driving the fan depending on the temperature value and the voltage value to the fan driving part.

12. The gas discharging control method of claim 8, wherein the reference temperature value is 70° C. and the reference voltage value is 4.7V.
